(19) United States
(12) Patent Application Publication
(10) Pub. No.: US 2023/0221687 A1
(43) Pub. Date: Jul. 13, 2023

(54) A SYSTEM AND METHOD FOR EVALUATION OF SAND COMPACTIBILITY

(71) Applicant: Deepak CHOWDHARY, Nagpur, Maharashtra (IN)

(72) Inventor: Deepak CHOWDHARY, Nagpur, Maharashtra (IN)

(73) Assignee: Deepak CHOWDHARY, Nagpur, Maharashtra (IN)

(21) Appl. No.: 18/021,166

(22) PCT Filed: Aug. 14, 2021
(86) PCT No.: PCT/IB2021/057504

§ 371 Date: Feb. 14, 2023

(30) Foreign Application Priority Data
Aug. 14, 2020 (IN) 202021034994

(51) Int. Cl. G05B 13/04; G05B 13/02

(52) U.S. Cl. CPC G05B 13/048; G05B 13/0265

(57) ABSTRACT

A system and method 300 for optimization of compactibility of sand in a foundry is disclosed, which ensure that compactibility of sand is maintained within desired values through the different stages of the foundry. A method to forecast compactibility of sand at downstream stages of the foundry based on sand compactibility data obtained from a sample drawn from an operation unit associated the different stages of sand molding and casting operations and supporting data sensed by one or more sensors related to at least one parameter of the sand, additives and environment of the operation unit from where the sample is collected. Based on predicted compactibility of the sand at one or more of the different stages, the compactibility set point is optimized and adjusted at a compactibility controller.

### TECHNICAL FIELD

The present disclosure generally relates to the technical field of foundries producing metal castings. More particularly, the present disclosure relates to a system and a method for optimization of compactibility of sand used in the foundry for the purpose of reducing casting rejections in a foundry.

### BACKGROUND

In green sand foundries producing metal castings, a sand mixing unit is configured for mixing sand with water and other additives, to achieve desired sand properties, amongst which sand compactibility being one of the most important properties. The compactibility of sand is very significant to get perfect casting, however, with several cycles of usage, the recycled sand tends to exhibit lesser compactibility and hence requires correct control of amount of water, additives as well as the mixing times. Moreover, the compactibility of sand tends to change or reduce, when standing in a hopper or when in other downstream operational units, such as sand molding unit, metal casting unit, and cooling unit.

The conventional compactibility controller usually adjusts the sand compactibility only in the sand mixing unit, wherein the compactibility controller checks the compactibility of a sand batch after mixing, and controls the addition of water using logic control, to achieve a desired compactibility. However, the sand compactibility tends to change, as the sand batch moves from the sand mixing unit to other downstream units such as sand molding unit, metal casting unit, and cooling unit. Further, the conventional compactibility controller utilizes logic to control addition of water only and no other aspects such as amount and type of additives and/or mixing times are controlled. The limited scope of the conventional compactibility controllers results in the sand loosing its properties in downstream stages of the casting lines causing rejections.

Hence, there is a need in the art, for an effective method and system for optimization of sand compactibility for the purpose of reducing casting rejections in a foundry.

### OBJECTS OF THE DISCLOSURE

It is a general object of the present disclosure to provide a system and method for optimization of compactibility of sand used in a foundry for the purpose of reducing casting rejections in the foundry.

An object of the present disclosure to provide a system and method that ensure that compactibility of sand is maintained within desired values through the different stages of the foundry.

An object of the present disclosure is to provide a method to forecast compactibility of sand at downstream stages of the foundry based on different parameters in the sand stream to decide if compactibility set point in the compactibility controller that controls compactibility of sand in sand mixing unit, needs to be adjusted.

An object of the present disclosure to provide a system and method that provide a compactibility set point for the compactibility controller that ensures that compactibility of sand is maintained within desired values through the different stages of the foundry.

Another object of the present disclosure is to provide a underlying relationship between compactibility set point and sensor logged readings for different parameters.

Another object of the present disclosure is to provide a method to convert the sensor logged reading to compactibility set point using the developed relationship between compactibility set point and sensor logged readings.

### SUMMARY

Aspects of the present disclosure relate to a foundry line that uses sand to prepare moulds for casting a molten metal to a desired shape. In particular, the present disclosure pertains to maintain compactibility of the sand throughout different stages of the foundry line so that rejection of castings from the foundry is minimized. More particularly, a system and method for optimizing a compactibility set point in a compactibility controller associated with the foundry is disclosed to ensure that compactibility of the sand throughout different stages of the foundry line is maintained.

In an aspect, the disclosed method and system are configured to predict compactibility of the sand at one or more of the different stages of sand molding and casting operations of the foundry based on sand compactibility data obtained from a sample drawn from an operation unit associated the different stages of sand molding and casting operations and supporting data related to at least one parameter of the sand, additives and environment of the operation unit from where the sample is collected, which is obtained from one or more sensors. Based on the predicted compactibility of the sand at one or more of the different stages, the compactibility set point is optimized and adjusted at the compactibility controller.

In an aspect, the disclosed method for optimization of compactibility of sand in a foundry includes the steps of (i) testing, using a compactibility tester, a sample of the sand from an operation unit associated with different stages of sand molding and casting operations of the foundry to obtain compactibility data associated with the sample; (ii) receiving, at a computing device, the compactibility data associated with the sample; (iii) receiving, at the computing device, from one or more sensors operatively coupled to the computing device, a supporting data related to at least one parameter of the sand, additives and environment of the operation unit from where the sample is collected; and (iv) predicting, at the computing device, based on the sand compactibility data obtained from the compactibility tester and the supporting data, compactibility of the sand at one or more of the different stages of the sand molding and casting operations of the foundry. The method further includes the step of performing, at a compactibility controller associated with the sand molding and casting operations of the foundry, when the estimated compactibility is found to be unacceptable, an adjustment to compactibility set point to achieve a desired compactibility at one or more of the different stages of the sand molding and casting operations of the foundry.

The method can further include the step of evaluating, at the computing device, the compactibility data obtained from the compactibility tester and the predicted compactibility to determine one or more attributes associated with optimization of the compactibility of the sand, and wherein the adjustment to the compactibility set point is carried out based on the determined one or more attributes. The one or more attributes associated with optimization of the compactibility of the sand can include at least one of amount of water, sand mixing time and amount of additives.

Evaluation of the compactibility data and the predicted compactibility to determine the one or more attributes can be done using a genetic algorithm model.

The supporting data related to the at least one parameter of the sand, additives and environment of the operation unit can be selected from at least one of green compression strength of sand, compactibility index, moisture content, active clay, inert fines content, loss on ignition percent, permeability index, wet tensile strength, volatile matter content, grain fineness number, American Foundry Society grain fineness number, oolitics content, pH value of the sand, humidity of the operation unit, temperature of the operation unit, recycled sand temperature, recycled sand moisture content, quality of sand additives and quantity of sand additives

Prediction of the compactibility of the sand can be done using a machine learning model, wherein the machine learning model is operable using any of a support vector regression model, ridge regression and a lasso regression. The machine learning model can be refined using gaussian process optimization with internal k-fold cross validation.

The step of predicting the compactibility of the sand can include: (i) pre-processing, at the computing device, the compactibility data and the supporting data, to remove one or more missing attributes present therein; and (ii) aligning, at the computing device, the compactibility data, and the supporting data, based on one or more timestamps present therein, to obtain collective datasets grouped based on similar timestamps.

Another aspect of the present disclosure relates to a system for optimization of compactibility of sand in a foundry, the system includes a compactibility controller; a compactibility tester configured to test a sample of sand from an operation unit associated with different stages of sand molding and casting operations of the foundry to obtain compactibility data associated with the sample; and one or more sensors configured to provide a supporting data related to at least one parameter of the sand, additives and environment of the operation unit from where the sand sample is collected. The system further includes one or more processors communicably coupled with the compactibility controller, the compactibility tester and the one or more sensors, and configured to: (i) predict, based on the sand compactibility data obtained from the compactibility tester and the supporting data, compactibility of the sand at one or more of the different stages of the sand molding and casting operations of the foundry; and (ii) perform, at the compactibility controller, when the estimated compactibility is found to be unacceptable, an adjustment to compactibility set point to achieve a desired compactibility at one or more of the different stages of the sand molding and casting operations of the foundry.

Various objects, features, aspects and advantages of the inventive subject matter will become more apparent from the following detailed description of preferred embodiments, along with the accompanying drawing figures in which like numerals represent like components.

### BRIEF DESCRIPTION OF DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

The diagrams are for illustration only, which thus is not a limitation of the present disclosure, and wherein:

FIG. 1 illustrates exemplary network architecture for implementation of the proposed system for optimization of compactibility of sand in a foundry, in accordance with an embodiment of the present disclosure.

FIG. 2 illustrates an exemplary representation of a first computing device of the system and/or a second computing device for optimization of compactibility of sand, in accordance with an embodiment of the present disclosure.

FIG. 3 is an exemplary flow diagram for the proposed method for optimization of compactibility of sand in a foundry, in accordance with an embodiment of the present disclosure.

FIG. 4A illustrates an exemplary flow diagram for a method to obtain datasets with corrected timestamps, in accordance with an embodiment of the present disclosure.

FIG. 4B illustrates an exemplary flow diagram for a method to obtain datasets with corrected timestamps for a supporting data including parameters related to the sand mixing unit, in accordance with an embodiment of the present disclosure.

FIG. 4C illustrates an exemplary flow diagram for a method to obtain datasets with corrected timestamps for a supporting data including parameters related to sand properties, in accordance with an embodiment of the present disclosure.

FIG. 4D illustrates an exemplary flow diagram for a method to obtain datasets with corrected timestamps for a supporting data including parameters related to operation unit, in accordance with an embodiment of the present disclosure.

FIG. 5A illustrates an exemplary flow diagram for a method for initialization and configuration of genetic algorithm solution routine, in accordance with an embodiment of the present disclosure.

FIG. 5B illustrates an exemplary flow diagram for a method for performing inverse optimization by implementing genetic algorithm, in accordance with an embodiment of the present disclosure.

FIG. 6 illustrates an exemplary flow diagram for a method for implementation of set point adjustment recommendation for configuring compactibility set point in the compactibility controller, in accordance with an embodiment of the present disclosure.

FIG. 7 illustrates a graphical representation of data considered as outliers, in accordance with an embodiment of the present disclosure.

### DETAILED DESCRIPTION

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

Embodiments described herein relate to a system and method for optimizing a compactibility set point in a compactibility controller associated with a foundry that uses sand for preparing moulds for casting a molten metal to a desired shape, wherein the optimized set point ensures that compactibility of the sand throughout different stages of the foundry line is maintained.

In an embodiment, the disclosed method and system are configured to predict compactibility of the sand at one or more of the different stages of sand molding and casting operations of the foundry based on sand compactibility data obtained from a sample drawn from an operation unit associated the different stages of sand molding and casting operations and supporting data related to at least one parameter of the sand, additives and environment of the operation unit from where the sample is collected, which is obtained from one or more sensors. Based on the predicted compactibility of the sand at one or more of the different stages, the compactibility set point is optimized and adjusted at the compactibility controller.

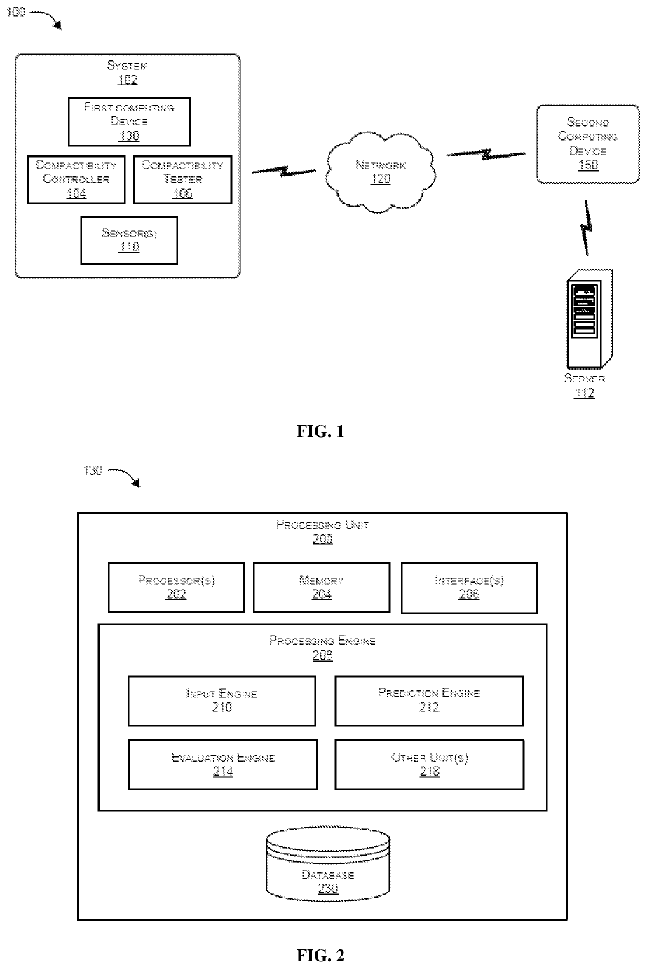

Referring to FIG. 1, where an exemplary architecture 100 for implementation of the disclosed a system 102 is shown, the system 102 may include a first computing device 130, a compactibility controller 104, a compactibility tester 106, and one or more sensors 110. The system 102 may be implemented by using any or a combination of hardware components and engine components such as a server 112, a computing system, a computing device, a security device and the like. The one or more components of the system 102 may communicate with a second computing device 150 over a network 120. The second computing device 150 may be connected to a server 112.

In an embodiment, the first computing device 150 may be associated with one or more input devices for providing one or more inputs to the system 102. The input device may include a touch pad, touch enabled screen of a computing device, an optical sensor, an image scanner and the like that may be used to receive an input that forms part of an input to the system 102. In an embodiment, the input device may be implemented such that it forms part of the first computing device 150.

In an implementation, the system 102 may be accessed by applications residing on any operating system, including but not limited to, Windows™. Android™ iOS™, and the like. Examples of the first computing device 130 and the second computing device 150 may include but are not limited to, a portable computer, a personal digital assistant, a handheld device, and a workstation.

In an embodiment, the compactibility controller 104 may be configured to receive a sand sample from at least one operation unit associated with sand molding and casting. The operation unit may be selected from at least one of sand mixing unit, a sand molding unit, a casting unit and a cast cooling unit. The sand mixing unit may be a unit configured for mixing of sand, water and additives in various ratios to achieve a desired compactibility of the sand. The sand molding unit can be a downstream unit and may be configured for obtaining sand moulds that include a pattern of a cast. The casting unit may be a further downstream unit configured for pouring molten metal or alloy into the pattern of the sand mould for obtaining the metal cast. The cooling unit is downstream to the casting unit and may be configured for allowing the cooling of the metal cast. The cooling unit may be further connected to a shakeout unit wherein the metal cast may be separated from the sand mould and the recycled sand may be sent back to the sand mixing unit. Various other units may also be included. The above referred units are also referred to as operation units or stages of the sand molding and casting operations of the foundry.

In an embodiment, the compactibility controller 104 may draw the sand sample from a sand mixing unit, which may involve continuous mixing of sand, water, and additive. The sand sample may be drawn from dry mixing stage or wet mixing stage of the sand mixing unit. In another embodiment, the sand sample may be obtained from the sand molding unit. In another embodiment, the sand sample may be obtained from the casting unit. In another embodiment, the sand sample may be obtained from a cooling unit involving cooling of cast metal in the sand mould followed by shaking off the sand mould to remove the cast metal. Various other embodiments are also possible.

In an embodiment, compactibility tester 106 may be configured to test the received sand sample to obtain sand compactibility data associated with the sand sample. In an embodiment, the compactibility tester 106 may be integrated with the compactibility controller 104. In an embodiment, the one or more sensors 110 may be coupled to the at least one operation unit and configured to sense one or more characteristics associated with sand used in the operation unit or conditions of the operation unit to obtain a supporting data. The supporting data may be selected from, but not limited to, at least one of Green Compression Strength (GCS), compactibility index, moisture content, active clay, inert fines content, Loss On Ignition percent (LOI), permeability index, wet tensile strength, volatile matter content, grain fineness number (GFN), American Foundry Society grain fineness number (AFS), additives content, pH value of the sand, humidity of the operation unit, temperature of the operation unit, prepared sand GFN, recycled sand temperature, recycled sand moisture content, quality of sand additives and quantity of sand additives. Various other parameters can also be included. The recycled sand may be the sand obtained from the cooling unit by shakeout of sand mould to separate the cast metal. The compactibility tester 104 may be a device which measures compactibility by application of pressure on sand in loose form. In an embodiment, the compactibility tester 104 may be integrated with the compactibility controller 104. Various other types of compactibility tester may also be used.

The one or more sensors 110 may include, but not limited to, an optical sensor, a moisture sensor, humidity measuring sensor, temperature sensor, or any sensor for measuring one or more characteristics of sand. Various other sensors used in foundries may be also used. In an embodiment, the one or more sensors 110 may be IoT devices coupled with the first computing device 130.

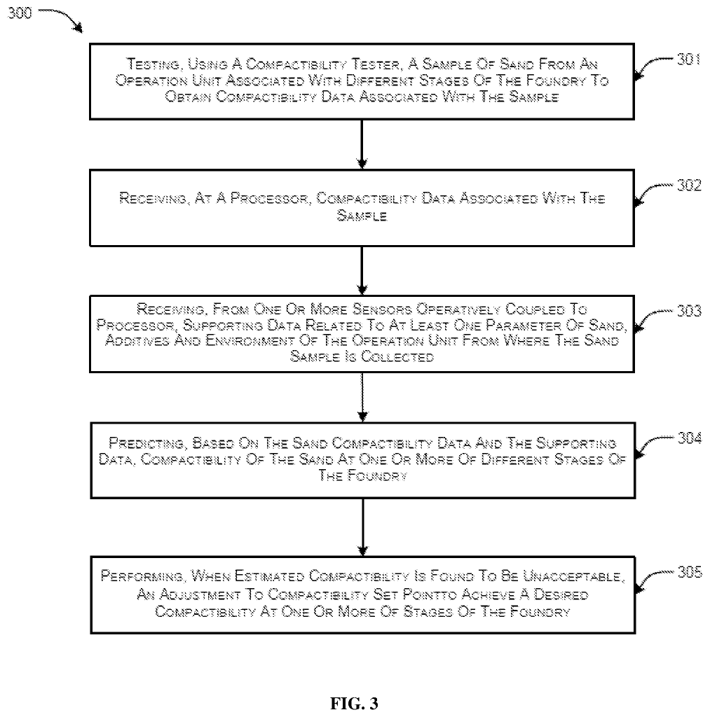

FIG. 2 illustrates an exemplary representation of the first computing device 130 of the system 102, wherein, as shown, the first computing device 130 may include a processor 200 having one or more processors 202. In an embodiment, the one or more processors 202 may be configured to predict an estimated sand compactibility of the sand sample based on the sand compactibility data obtained from the compactibility tester 106 and the supporting data obtained from the one or more sensors 110; and evaluate the sand compactibility data obtained from the compactibility tester 106 and the estimated sand compactibility to determine one or more attributes associated with the optimization of the sand compactibility for the purpose of reducing casting rejections in the foundry. In an embodiment, the one or more attributes may be indicative of a set point value of the sand compactibility in the at least one operation unit for the purpose of reducing the casting rejections in the foundry. In an embodiment, the set point value may be configured at the compactibility controller 104 to optimize one or more parameters associated with optimization of the sand compactibility for the purpose of reducing casting rejections in the foundry, wherein the one or more parameters may be selected from at least one of amount of water, sand mixing time and amount of additives.

In an aspect and as illustrated in FIG. 2, the one or more processors 202 may be implemented as one or more microprocessors, microcomputers, microcontrollers, digital signal processors, central processing units, logic circuitries, and/or any devices that manipulate data based on operational instructions. Among other capabilities, the one or more processor(s) 202 may be configured to fetch and execute computer-readable instructions stored in a memory 204 of the system 102. The memory 204 may store one or more computer-readable instructions or routines, which may be fetched and executed to create or share the data units over a network service. The memory 204 may comprise any non-transitory storage device including, for example, volatile memory such as RAM, or non-volatile memory such as EPROM, flash memory, and the like.

The first computing device 130 of the system 102 may also comprise an interface(s) 206. The interface(s) 206 may comprise a variety of interfaces, for example, interfaces for data input and output devices, referred to as I/O devices, storage devices, SCADA, Sensors and the like. The interface(s) 206 may facilitate communication of the system 102 with various devices coupled to the system 102 such as the computing device 108. The interface(s) 206 may also provide a communication pathway for one or more components of the system 102. Examples of such components include, but are not limited to, processing engine(s) 202 and database 230.

The one or more processors 202 may be implemented as a combination of hardware and programming (for example, programmable instructions) to implement one or more functionalities of the one or more processors 202. In examples described herein, such combinations of hardware and programming may be implemented in several different ways. For example, the programming for the one or more processors 202 may be processor executable instructions stored on a non-transitory machine-readable storage medium and the hardware for the one or more processors 202 may comprise a processing resource (for example, one or more processors), to execute such instructions. In the present examples, the machine-readable storage medium may store instructions that, when executed by the processing resource, implement the one or more processors 202. In such examples, the system 102 may comprise the machine-readable storage medium storing the instructions and the processing resource to execute the instructions, or the machine-readable storage medium may be separate but accessible to the system 102 and the processing resource. In other examples, the one or more processors 202 may be implemented by electronic circuitry.

In an aspect, the database 230 may be configured to store any or a combination of sand compactibility data, the supporting data, estimated sand compactibility, and one or more attributes indicative of set point value of the sand compactibility. In another aspect, the database 230 may comprise data that is either stored or generated as a result of functionalities implemented by any of the components of the processing engine(s) 202.

In an exemplary embodiment, the processing engine(s) 208 may include an input engine 210, a prediction engine 212, an evaluation engine 214 and other engines 218 wherein the other engines 220 may further include, without limitation, sample information receiving engine, event generation engine, storage engine, or signal generation engine. In an exemplary embodiment, the input engine 210 may receive one or more inputs selected from sand compactibility data as obtained by testing of one or more sand samples by the compactibility tester 106, and the supporting data obtained from the one or more sensors 110. In an exemplary embodiment, the prediction engine 212 may be configured to predict an estimated sand compactibility of the sand sample based on the sand compactibility data obtained from the compactibility tester and the supporting data. In an embodiment, the prediction engine 212 may predict the estimated sand compactibility using a machine learning model, wherein the machine learning model is operable using any of support vector regression model, ridge regression and lasso regression.

In an exemplary embodiment, the evaluation engine 214 may be configured to evaluate the sand compactibility data obtained from the compactibility tester 106 and the estimated sand compactibility obtained from the prediction engine 212 to determine one or more attributes associated with the optimization of the sand compactibility for the purpose of reducing casting rejections in the foundry. In an exemplary embodiment, the evaluation engine 214 may evaluate the sand compactibility data and the estimated sand compactibility, to determine the one or more attributes by using genetic algorithm model. In an embodiment, it would be appreciated that the system 102 may be processed in an automated mode without human intervention and would reduce the time duration related to evaluation of sand compactibility.

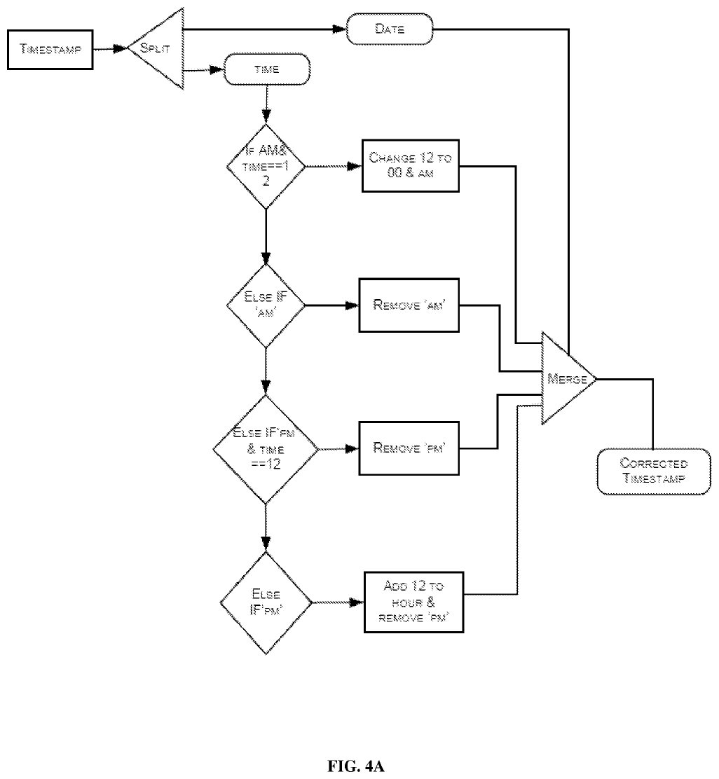

Referring to FIG. 3 where a flow diagram for the disclosed method 300 for optimization of compactibility of sand in a foundry is shown, the method 300 can include the steps 301 of testing, using a compactibility tester, such as compactibility tester 106 shown in FIG. 1, a sample of the sand from an operation unit associated with different stages of sand molding and casting operations of the foundry to obtain compactibility data associated with the sample. At step 302 of the method 300, the compactibility data associated with the sample can be received at a computing device, such as first computing device 130 shown in FIG. 1. Further, at step 303, the computing device 130 can receive, from one or more sensors, such as sensors 110 shown in FIG. 1, which are operatively coupled to the computing device 130, a supporting data related to at least one parameter of the sand, additives and environment of the operation unit from where the sample is collected. In an aspect of the method 300, at step 304, the computing device 130 can predict, based on the sand compactibility data obtained from the compactibility tester and the supporting data, compactibility of the sand at one or more of the different stages of the sand molding and casting operations of the foundry.

In an embodiment, when the estimated compactibility is found to be unacceptable, the method 300 can include the step 305 of performing, at a compactibility controller, such as compactibility controller 104 shown in FIG. 1, associated with the sand molding and casting operations of the foundry, an adjustment to compactibility set point to achieve a desired compactibility at one or more of the different stages of the sand molding and casting operations of the foundry.

The method 300 can further include the step of evaluating, at the computing device 130, the compactibility data obtained from the compactibility tester 106 and the predicted compactibility to determine one or more attributes associated with optimization of the compactibility of the sand. The adjustment to the compactibility set point can be carried out based on the determined one or more attributes. The one or more attributes associated with optimization of the compactibility of the sand can include at least one of amount of water, sand mixing time and amount of additives.

In an embodiment, the step of predicting the compactibility of sand can be done using, but not limited to, a machine learning model. In an embodiment, step of predicting the compactibility may include pre-processing the sand compactibility data and the supporting data, by the computing device 130202, to remove one or more missing attributes present therein. The sand compactibility data obtained from the compactibility tester 106 by testing of the sample of sand from one or more operation units, such as sand mixing unit, a sand molding unit, a casting unit and a cast cooling unit, may include a timestamp, wherein the time stamping may be related to the time at which a sample may be obtained from the operation unit and/or the time at which the sand sample may be tested. The supporting data, as obtained by sensing of one or more characteristics of sand or the operation unit, by the one or more sensors 110, may include a timestamp, based on the time the sensors 110 may have sensed the one or more characteristics. In an embodiment, the sand compactibility data and the supporting data, may be categorized based on their respective timestamp, wherein the sand compactibility data and the supporting data may be envisioned to be joined or categorized based on a common timestamp index column for the purpose of generating a dataset for machine learning model training.

In an embodiment, if the sand compactibility data or the supporting data measurements include missing field values, then average of the measurements may be taken for the dataset spanning the machine learning training period. In another embodiment, if the sand compactibility data or the supporting data measurements include entire missing record, then the record may be envisioned to be removed in its entirety. In an embodiment, the timestamps may be considered in the same and singular time-zone, persisted in a format following the time related information in a format {DD/MM/YYYY hh:mm:ss}.

In an embodiment, predicting the compactibility of sand may include aligning, by the computing device 130, the compactibility data, and the supporting data, based on one or more timestamps present therein, to obtain collective datasets grouped based on similar timestamps. In an embodiment, the step of aligning the data may be done after the step of pre-processing as discussed earlier, wherein the data with uniform sampling frequency corresponding to a definite time interval may be joined based on timestamp or a time related information in a native format. In an embodiment, the definite time interval may be in the range of 0.5 hours to 4 hours. In an exemplary embodiment, when the measurement frequency may not be uniform, then any step selected from resampling, bucketing and grouping the time series based on shift wise time period, may be envisioned, wherein dividing the day into slots may create a fixed number of time slots for joining or aligning of the sand compactibility data, and the supporting data. The bucketing may be done such that it excludes large time intervals (corresponding to lesser number of shifts), which can cause undesired smoothing of the data. In an exemplary embodiment, the data may be categorized or aligned into several time slots based on definite time interval of 4 hours, as shown in Table 1, which may be obtained by bifurcation of each of 8 hours shift into 2 sub-shifts thus categorizing data corresponding to 6 different time intervals (labeled as shift nomenclature A1, A2, B1, B2, C1, C2) having definite time interval of 4 hours. As shown in Table 1, each shift nomenclature is representative of mean taken for the data points within the selected time slots for creating uniformity in the data in terms of timestamps.

TABLE 1
Time interval for categorizing data during aligning step

| Time slot | Shift nomenclature |
|---|---|
| 06:00-09:59 | A1 |
| 10:00-13:59 | A2 |
| 14:00-17:59 | B1 |
| 18:00-21:59 | B2 |
| 22:00-01:59 | C1 |
| 02:00-05:59 | C2 |

In an embodiment, during pre-processing and/or the aligning steps, the sand compactibility data and the supporting data may be grouped or categorized into plurality of datasets, wherein the sand compactibility data may be an output variable whereas the supporting data may be an input variable. The plurality of datasets may be sent to the computing device 130 for predicting the estimated sand compactibility of the sand sample, using machine learning model. In an embodiment, the method may include processing or analysis of the plurality of datasets for estimating accuracy of the machine learning model and/or to assess the influence of time intervals on the machine learning model, involving grouping datasets with definite time intervals of 1 hour, 2 hours and 4 hours. The datasets thus generated may be stored in a training dataset table, wherein the nature of database may be specific to the foundry with explicit user roles and data management functions.

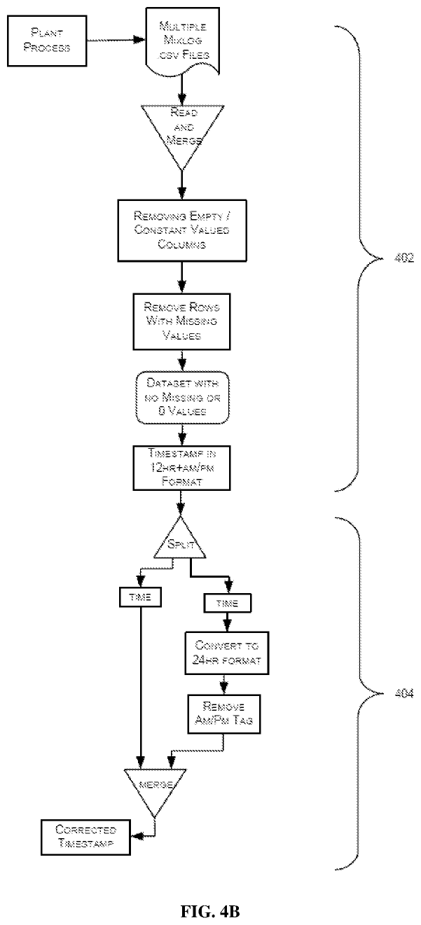

FIG. 4A illustrate a procedure to obtain datasets with corrected timestamps. FIG. 4A illustrate a flow diagram depicting a procedure to obtain datasets with corrected timestamps, in accordance with an embodiment of the present disclosure. FIG. 4B illustrate an exemplary flow diagram depicting the multiple steps (represented by 402) for pre-processing of the supporting data including parameters related to sand mixing unit, for removing missing values and missing entries, and steps (represented by 404) related to aligning the supporting data including parameters related to the sand mixing unit such as recycled sand temperature, recycled sand moisture content, quality of sand additives and quantity of sand additives. FIG. 4C illustrate an exemplary flow diagram for generating timestamps using data and time of each data value in the supporting data including parameters related to sand properties such as Green Compression Strength (GCS) of sand, compactibility index, moisture content, active clay, inert fines content, Loss On Ignition percent (LOI), permeability index, wet tensile strength, volatile matter content, grain fineness number (GFN), American Foundry Society grain fineness number (AFS), oolitics content, pH value of the sand. FIG. 4D illustrate an exemplary flow diagram for formatting the time and generating timestamps using in the supporting data including parameters related to operation unit such as humidity of the operation unit and temperature of the operation unit.

In an embodiment, predicting the estimated sand compactibility, by using a machine learning model, which may be operable using any technique including, but not limited to, support vector regression model, ridge regression model, lasso regression model and artificial neural networks. The accuracy of the prediction by the machine learning model may be tested by using performance indicators including, but not limited to, R2 (coefficient of determination), adjusted R2 and RMSE (root mean squared error). In order to better understand the underlying behavior of model, two variants based on the standardization of data may be developed. In one embodiment of the preprocessing step, the data may be recommended to be mean centered and scaled to unit variance. In another embodiment of the preprocessing step, the data may not be in standardized form and not mean centered. The sand compactibility data may be the target variable (y), whereas the supporting data may be predictor variables (X), wherein the performance metrics are as shown in Table 2.

TABLE 2
Accuracy prediction of machine learning
model by performance indicators

| | Standardised data | | |
|---|---|---|---|
| Algorithm | R² | Adj. R² | RMSE |

Unregularized

| | | | |
|---|---|---|---|
| Linear regression | 0.510 | 0.501 | 1.267 |

Regularized

| | | | |
|---|---|---|---|
| Ridge regression | 0.509 | 0.500 | 1.268 |
| LASSO regression | 0.510 | 0.501 | 1.267 |

SVR

| | | | |
|---|---|---|---|
| Linear | 0.502 | 0.493 | 1.277 |
| RBF | 0.604 | 0.597 | 1.139 |
| Polynomial (deg = 2) | 0.569 | 0.561 | 1.188 |

In an embodiment, the machine learning model may be refined by using gaussian process optimization with internal k-fold cross validation. The cross-validation (CV) may further split a training dataset (as obtained earlier after pre-processing and aligning steps) into CV training and testing sets, wherein (k−1) folds may be used for training the model and the k^{th} fold may be used for testing the result, and at any given iteration, a total of (k) results can be available. In an embodiment, a set of hyper-parameters may be supplied from a gaussian process which employs Bayesian optimization, wherein the function values may be assumed to follow a multivariate normal distribution and a gaussian surrogate model may be built based on identified distributions in the data. The next set of hyper-parameters may be predicted from the surrogate model, and the process may iterate based on the user input. The range of hyperparameters provided to the gaussian process may generate the search space for the optimization algorithm, wherein the range provided may be 0.1-10 for C, 0.01-1 for gamma, and 0.1-1 for epsilon. As a result, the optimized set of parameters are: C=2.243; Gamma=0.143; Epsilon=0.330, as per an exemplary embodiment.

In an embodiment, the refined model may be stored in a database along with metadata characterizing the foundry name, moulding line, operating ranges of the sand plant, observed range of the sand properties, period of data used model training, validation metrics of the model and estimated period of utility for the build model before it is pertinent to update the model. In an exemplary embodiment, optimized set of hyper-parameters i.e. C, gamma and epsilon may be utilized in original model building stage, wherein the tuned SVR model gives R2 score=0.606, adjusted R2=0.601 and RMSE=1.136. The trained model thusly may be used to derive the estimated sand compactibility at any operation unit.

The optimal frequency of sample for data aligning may be identified by way of sampling over a range of frequencies and the optimal frequency may selected by way of cross validation of the model trained on that frequency that results in the lowest validation error. The performance of the machine learning models obtained from various sampling frequencies, may be as shown in Table 3, wherein the values of performance indicators for 4 hours duration seem to be very similar as in the case of 1 and 2-hour sampling frequency. Hence significant improvement can be seen in the case of 4-hour sampling frequency, thus requiring to obtain measurements for 4 hours as sampling frequency for the data alignment stage.

TABLE 3
Accuracy prediction at different sampling frequency

| | Sampling frequencies | | |
|---|---|---|---|
| | 1 hour | 2 hours | 4 hours |
| RMSE | 1.210 | 1.279 | 1.411 |
| R² | 0.510 | 0.490 | 0.606 |

In an embodiment, evaluating the sand compactibility data and the estimated sand compactibility, to determine the one or more attributes may be done by using genetic algorithm (GA) model. The GA model is a multi agent, directed random search algorithm, wherein GA may be envisioned for inverse optimization for all types of machine learning algorithm, wherein inverse optimization refers to determining appropriate compactibility to be maintained in the event of discharge of sand from the sand mixing unit.

Recommendations on the Optimal Value of Compactibility to be Maintained During the Event of Discharge from the Sand Mixing Unit:

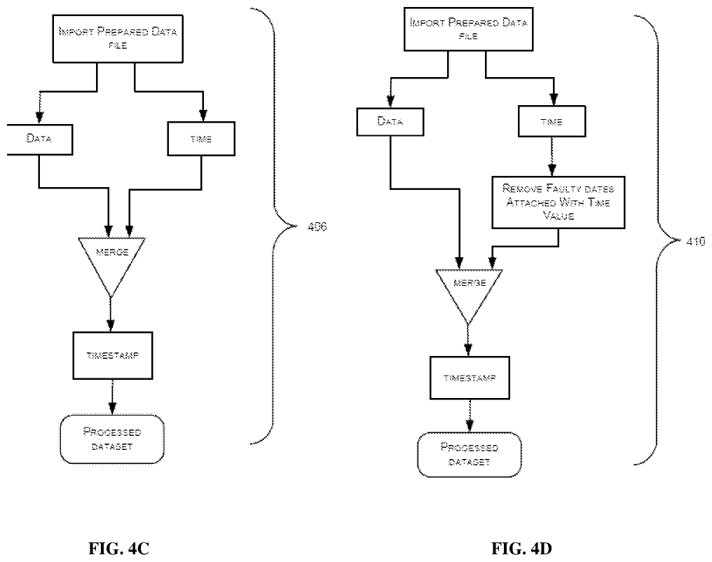

In the GA model, a real valued chromosome may be considered in the problem as the compactibility set point, which may be a continuous value. In one embodiment of the optimization framework, a population size of 100 may be considered, which means a total of 100 chromosomes may be considered at any given generation, wherein a generation relates to number of iterations in GA terminology, ranging from 10 to 1,000,000. It may be appreciated that the terminologies used herein related to the genetic algorithm model are related to analytical field and can be interpreted as defined in the art. In an embodiment, the step of evaluating using GA model may include a procedure of initialization and configuration of genetic algorithm solution routine, as shown in the flow diagram of FIG. 5A, wherein a total of 100 generations may be considered in the algorithm as the value of fitness function stabilizes before GA terminates, termination criteria set for GA being the total number of generations i.e. 100. As shown in FIG. 5A, the implementation of genetic algorithm may include a step of generating random chromosomes until a set number is reached (step 502), followed by which all essential parameters are accumulated for prediction (step 504), and the estimated sand compactibility may be obtained by prediction using machine learning model (SVR model) (step 506). The accuracy of prediction may be verified using performance indicators, as discussed earlier. Based on a fitness function in GA, high fitness chromosomes may be selected (step 508) for further processing including crossover and mutation performed using any of simulated binary-bounded or bounded-polynomial approach.

The fitness function in GA may be taken as the minimization of squared distance between desired sand compactibility and estimated sand compactibility.

Predicted sand compactibility(ŷ)=SVR_{rbf}(parameters)

Fitness function=(desired sand compactibility−estimatedsand compactibility)²

Hence the objective function is Z=argmin (yₒₚₜᵢₘₐₗ−ŷ(_{compactibility set point}))²

Due to the nature of constrained optimization, bounds may be implemented on the decision variable. The objective function solution may be subject to the following constraints:

lower bound≤(compactibility set point)≤upper bound.

These bounds may be enforced to adhere to safe operating ranges of the sand mixing unit as well as to recommend discharge compactibility values from a proven operating range that the sand plant is designed for. Therefore, it may be important to provide legitimate bounds on compactibility values for the compactibility controller. For bound setting, the minimum and maximum values may be envisioned to be taken from the training dataset itself, and care may be taken while dealing with lower bound as lab desired compactibility must not go below compactibility range of the compactibility controller. In order to impose this condition, lower bound is taken as the desired lab compactibility value.

Boundₘᵢₙ=desired sand compactibility value; and

Boundₘₐₓ=maximum value of compactibility from cleaned and preprocessed data

In an embodiment, the implementation of genetic algorithm may include performing inverse optimization, as shown in the flow diagram of FIG. 5B. In order to maintain the decision variable within bounds, the new population may be generated in every iteration (generation) of GA from the action of mutation and crossover operation on the selected chromosomes in the initialization step (steps 510, 512). The new population generated (step 514) may be plugged into the prediction model to evaluate their fitness values (step 516). A stopping criteria may be added (step 518) such that GA may be terminated once maximum number of generations may be meet the stopping criteria (step 520). During the operation of the offspring generation, if the generated compactibility may be estimated to lead beyond the bounds set in the previous stage, then corrective action must be taken in order to bring it within bounds, by equalizing the estimated value to the lower or upper bounds. At the end of the solving procedure, the globally best-fit chromosome may be reported the algorithm. This may refer to the compactibility at the event of discharge from the sand mixing unit that achieves the desired lab compactibility and minimizes the squared error.

In an embodiment, the set point value as evaluated by the GA model, may be set at the compactibility controller to optimize one or more parameters associated with optimization of the sand compactibility for the purpose of reducing casting rejections in the foundry, wherein the one or more parameters may be selected from at least one of amount of water, sand mixing time and amount of additives. The set point value can be provided at the compactibility controller 104 at the sand mixing unit, wherein the compactibility controller 104 can adjust the one or parameters using program logic controller (PLC) for obtaining optimized compactibility at sand mixing unit. In another embodiment, the set point value can be used for obtaining optimized compactibility at other downstream units such as the sand molding unit, the casting unit and the cast cooling unit.

### Recommendations on the Compactibility Setpoint Adjustments in the Sand Compactibility Controller

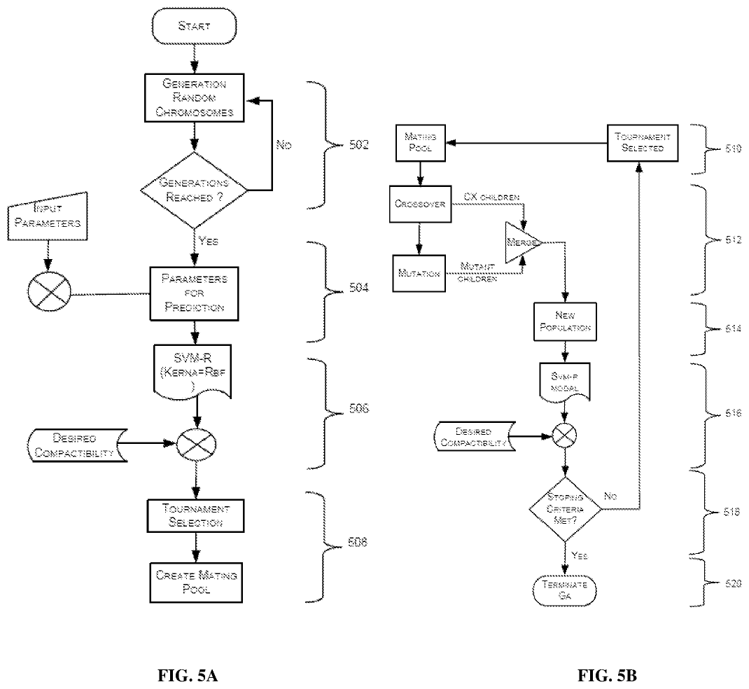

In an embodiment, the implementation of set point adjustment may be recommended for configuring the set point in the compactibility controller, as shown in the flow diagram of FIG. 6. In an exemplary embodiment, logged values of compactibility at the event of discharge from the sand mixing unit, as recorded by the compactibility controller (Compactibility sensor logged value) may be obtained, and the logged values may be converted or adjusted to the set point value, using a model including, but not limited to a variable regression model or a linear regression model. An exemplary representation of the set point adjustment is provided using linear model, as shown in FIG. 6. The resulting modeling delivers the following equation:

Compactibility_{set_point}=C+M*Compactibility_{logged},

where C=2.3151, M=0.946. The R2 score when a 4-hour time interval is considered has been observed to be 0.98, and the same when the time interval is 1 hour is 0.95 indicating the presence of strong relationships. At the end of the procedure, the globally best-fit compactibility set point may be reported for adjustment, wherein the set point value may be envisioned to be configured in the compactibility controller to achieve the desired compactibility at any or all stages downstream of the mixer discharge outlet. Various other embodiments are also possible.

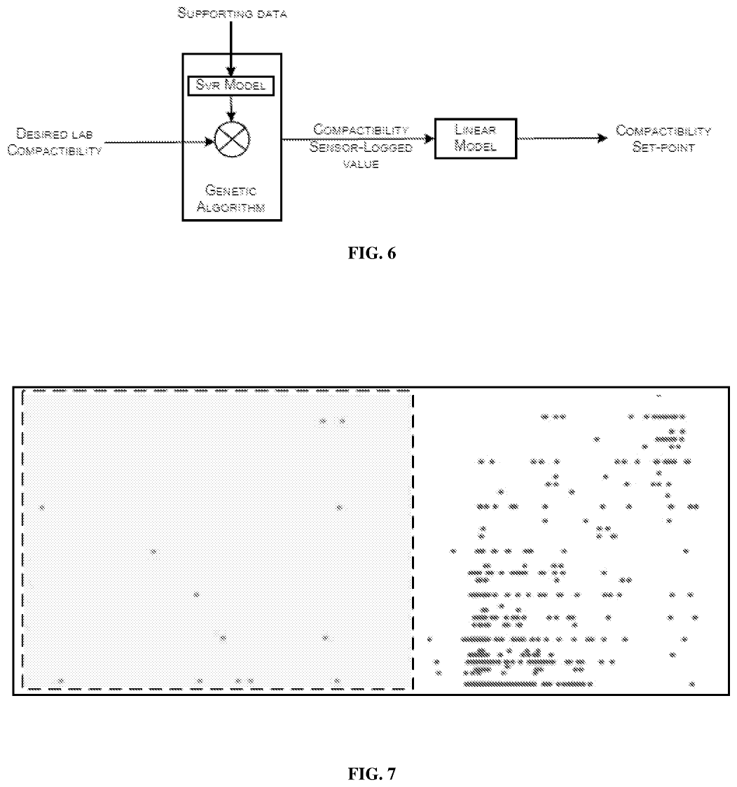

In an embodiment, the plurality of datasets from pre-processing and/or the aligning steps, may also be subjected for removal of any outliers. It may be appreciated that compactibility of the sand discharged from the mixer shall always be higher than the value of compactibility measured from a sand sample sampled from the moulding line. Hence, any values of compactibility which may be contradictory to this trend may be considered as the outliers and hence may be discarded from consideration, as shown in FIG. 7, for reducing the error margin. As shown in FIG. 7, the values in dataset which lie within the dotted rectangle may be the outliers and hence may be discarded.

Thus, the present disclosure provides an efficient system and method for optimization of compactibility of sand, which ensures that compactibility of sand is maintained within desired values through the different stages of the foundry. A method to forecast compactibility of sand at downstream stages of the foundry based on different parameters in the sand stream is also disclosed, which helps to decide if compactibility set point in the compactibility controller that controls compactibility of sand in sand mixing unit, needs to be adjusted.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

### Advantages of the Present Disclosure

The present disclosure provides a system and method for optimization of compactibility of sand used in a foundry for the purpose of reducing casting rejections in the foundry.

The present disclosure provides a system and method that ensure that compactibility of sand is maintained within desired values through the different stages of the foundry.

The present disclosure provides a method to forecast compactibility of sand at downstream stages of the foundry based on different parameters in the sand stream to decide if compactibility set point in the compactibility controller that controls compactibility of sand in sand mixing unit, needs to be adjusted.

The present disclosure provides a system and method that provide a compactibility set point for the compactibility controller that ensures that compactibility of sand is maintained within desired values through the different stages of the foundry.

The present disclosure provides a underlying relationship between compactibility set point and sensor logged readings for different parameters.

The present disclosure provides a method to convert the sensor logged reading to compactibility set point using the developed relationship between compactibility set point and sensor logged readings.

I claim:

1. A method for optimization of compactibility of sand in a foundry, the method comprising:
testing, using a compactibility tester, a sample of the sand from an operation unit associated with different stages of sand molding and casting operations of the foundry to obtain compactibility data associated with the sample;
receiving, at a computing device, the compactibility data associated with the sample;
receiving, at the computing device, from one or more sensors operatively coupled to the computing device, a supporting data related to at least one parameter of the sand, additives and environment of the operation unit from where the sample is collected;
predicting, at the computing device, based on the sand compactibility data obtained from the compactibility tester and the supporting data, compactibility of the sand at one or more of the different stages of the sand molding and casting operations of the foundry; and
performing, at a compactibility controller associated with the sand molding and casting operations of the foundry, when the estimated compactibility is found to be unacceptable, an adjustment to compactibility set point to achieve a desired compactibility at one or more of the different stages of the sand molding and casting operations of the foundry.

2. The method as claimed in claim 1, further comprising the step of evaluating, at the computing device, the compactibility data obtained from the compactibility tester and the predicted compactibility to determine one or more attributes associated with optimization of the compactibility of the sand, and wherein adjustment to the compactibility set point is carried out based on the determined one or more attributes; wherein the one or more attributes associated with optimization of the compactibility of the sand include at least one of amount of water, sand mixing time and amount of additives.

3. The method as claimed in claim 2, wherein evaluation of the compactibility data and the predicted compactibility to determine the one or more attributes is done using a genetic algorithm model.

4. The method as claimed in claim 1, wherein the supporting data related to the at least one parameter of the sand, additives and environment of the operation unit is selected from at least one of green compression strength of sand, compactibility index, moisture content, active clay, inert fines content, loss on ignition percent, permeability index, wet tensile strength, volatile matter content, grain fineness number, American Foundry Society grain fineness number, oolitics content, pH value of the sand, humidity of the operation unit, temperature of the operation unit, recycled sand temperature, recycled sand moisture content, quality of sand additives and quantity of sand additives

5. The method as claimed in claim 1, wherein predicting the compactibility of the sand is done using a machine learning model, wherein the machine learning model is operable using any of a support vector regression model, ridge regression and a lasso regression; and wherein the machine learning model is refined by using gaussian process optimization with internal k-fold cross validation.

6. The method as claimed in claim 1, wherein the step of predicting the compactibility of the sand comprises:
pre-processing, at the computing device, the compactibility data and the supporting data, to remove one or more missing attributes present therein; and
aligning, at the computing device, the compactibility data, and the supporting data, based on one or more timestamps present therein, to obtain collective datasets grouped based on similar timestamps.

7. A system for optimization of compactibility of sand in a foundry, the system comprising:
a compactibility controller;
a compactibility tester configured to test a sample of sand from an operation unit associated with different stages of sand molding and casting operations of the foundry to obtain compactibility data associated with the sample;
one or more sensors configured to provide a supporting data related to at least one parameter of the sand, additives and environment of the operation unit from where the sand sample is collected;
one or more processors communicably coupled with the compactibility controller, the compactibility tester and the one or more sensors, and configured to:
predict, based on the sand compactibility data obtained from the compactibility tester and the supporting data, compactibility of the sand at one or more of the different stages of the sand molding and casting operations of the foundry; and
perform, at the compactibility controller, when the estimated compactibility is found to be unacceptable, an adjustment to compactibility set point to achieve a desired compactibility at one or more of the different stages of the sand molding and casting operations of the foundry.

8. The system as claimed in claim 7, wherein the one or more processors are configured to evaluate, at the processor, the compactibility data obtained from the compactibility tester and the predicted compactibility to determine one or more attributes associated with optimization of the compactibility of the sand, and wherein the adjustment to the compactibility set point is carried out based on the determined one or more attributes; wherein the one or more attributes associated with optimization of the compactibility of the sand includes at least one of amount of water, sand mixing time and amount of additives.

9. The system as claimed in claim 8, wherein one or more processors are configured to evaluate the compactibility data and the predicted compactibility using genetic algorithm model.

10. The system as claimed in claim 7, wherein the supporting data related to the at least one parameter of the sand, additives and environment of the operation unit is selected from at least one of green compression strength of sand, compactibility index, moisture content, active clay, inert fines content, loss on ignition percent, permeability index, wet tensile strength, volatile matter content, grain fineness number, American Foundry Society grain fineness number, oolitics content, pH value of the sand, humidity of the operation unit, temperature of the operation unit, recycled sand temperature, recycled sand moisture content, quality of sand additives and quantity of sand additives.
